(19) United States
(12) Patent Application Publication
(10) Pub. No.: US 2022/0162496 A1
(43) Pub. Date: May 26, 2022

(54) FLUIDS FOR SINGLE AND MULTI PAD DELIVERY

(71) Applicant: Halliburton Energy Services, Inc., Houston, TX (US)

(72) Inventors: Denise Nicole BENOIT, Houston, TX (US); Enrique Antonio REYES, Houston, TX (US); Antonio RECIO, III, Houston, TX (US); Ronald Glen DUSTERHOFT, Houston, TX (US)

(21) Appl. No.: 17/527,746

(22) Filed: Nov. 16, 2021

Related U.S. Application Data
(60) Provisional application No. 63/117,842, filed on Nov. 24, 2020.

(51) Int. Cl. C09K 8/58

(52) U.S. Cl. CPC C09K 8/58

(57) ABSTRACT

A method of servicing one or more wellbores penetrating a subterranean formation comprising placing into at least one of one or more injection wells a communication enhancing fluid, wherein the subterranean formation comprises a plurality of zones having a natural resource proximate to the at least one of the one or more injection wells, wherein the communication enhancing fluid establishes a fluid communication network between at least a portion of the plurality of zones, and wherein establishing of the fluid communication network results in an increased production of the natural resource from one or more production wells penetrating the subterranean formation.

### CROSS-REFERENCE TO RELATED APPLICATIONS

This application claims priority under 35 U.S.C. § 119(e) to U.S. Provisional Patent Application No. 63/117,842 filed on Nov. 24, 2020 and entitled “Fluids for Single and Multi Pad Delivery,” the disclosure of which is hereby incorporated herein by reference in its entirety.

### FIELD

This application relates to the recovery of natural resources from a wellbore penetrating a subterranean formation, and more specifically this application relates to compositions and methods used in improved or enhanced oil recovery (EOR) operations.

### BACKGROUND

Natural resources such as gas, oil, and water residing in a subterranean formation or zone are usually recovered by drilling a wellbore down to the subterranean formation. Primary recovery refers to the first stage of hydrocarbon production, in which natural reservoir energy displaces hydrocarbons from the reservoir into the wellbore. Initially, the reservoir pressure is considerably higher than the bottomhole pressure inside the wellbore. This high natural differential pressure drives hydrocarbons toward the well and up to surface. However, as the reservoir pressure declines because of production, so does the differential pressure. To reduce the bottomhole pressure or increase the differential pressure to increase hydrocarbon production, it typically becomes necessary to implement an artificial lift system, such as a rod pump, an electrical submersible pump or a gas-lift installation. The primary recovery stage reaches its limit either when the reservoir pressure is so low that the production rates are not economical, or when the proportions of gas or water in the production stream are too high. During primary recovery, only a small percentage of the initial hydrocarbons in place are produced, typically around 10% for oil reservoirs. Following primary recovery, a variety of improved or enhanced oil recovery (EOR) methods may be employed to recover additional amounts of hydrocarbons from the wellbore and surrounding subterranean formation.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 shows an aerial view of the movement of fluid between stages.

FIG. 2 shows an exemplary completion schedule and well placement.

FIGS. 3A-3H illustrate water soluble chemical tracer analysis during flowback/production. Each figure represents an inter-well tracer test with tracer injected in a well (enclosed by a square) and observed at all wells. The numbers on the well (and the color) represents the normalized tracer concentration at that well (high numbers indicate more tracer observed).

FIG. 4A provides an aerial view of microseismic for an 11 well completion program.

FIG. 4B provides a side view of microseismic for an 11 well completion program.

### DETAILED DESCRIPTION

Wellbore treatment methods often are used to increase hydrocarbon production by using a treatment fluid to affect a subterranean formation in a manner that increases oil or gas flow from the formation to the wellbore for removal to the surface. In one or more embodiments, chemical stimulation and ultimately flow capacity is improved by using chemicals to alter formation properties.

Disclosed herein are compositions for improving communication between zones in a subterranean formation having a natural resource such as a hydrocarbon. Herein such compositions are termed communication enhancing fluids, CEFs. In some embodiments, the CEF and methods disclosed herein increase the effective permeability of the zone by dissolving materials in or etching the subterranean formation; decreasing capillary pressure within a subterranean formation; reducing interfacial tension between oil and water alter wettability of at least a portion of cone; enhancing differential dissolution of carbonate-rich mineral surfaces; enhancing the wetting of siliceous surfaces without dissolution of silicates minerals; or a combination thereof.

In some embodiments, a method of the present disclosure placement of a CEF across single and multiple wells for more effective treatment and enhanced recovery of natural resources from the reservoir. Further CEFS and the methods disclosed herein allow for the CEF to be utilized in single wells between stages or in the case of a multi-well system utilized to harness fluid communication as a way to more effectively treat the full reservoir with minimal treatment volumes and cost. Accordingly, the CEFS and methods disclosed herein result in the utilization of fracture-to-fracture and well-to-well communication to distribute the CEF through-out a reservoir to improve production. Also disclosed herein is a CEF that is shown to induce higher rates of water imbibition, to increase the native permeability, and to water wet the rock surface to mobilize more oil from the matrix.

In some embodiments, the communication fluids of the present disclosure are placed in reservoirs that can be characterized as “low permeability” or “tight” reservoirs. In some embodiments, the subterranean formation comprises an ultra-low permeability shale, a low permeability carbonate rich shale, a fractured carbonate reservoir, a sandstone reservoir, an unconventional reservoir or a combination thereof.

In some embodiments, a low permeability unconventional reservoir includes very low permeability carbonate rich shale, which is drilled as horizontal wells. Such reservoirs may have been either acid-stimulated or hydraulically-fractured during the initial completion to achieve better reservoir connectivity and higher early production rates. Due to the low matrix permeability, however, these wells are subject to rapid depletion under primary production conditions, meaning that the production rate will decline very fast in a relatively short period of time due to pressure depletion within the reservoir. Herein “low permeability” refers to a reservoir having a permeability ranging from about 0.00001 millidarcies (mD) to about 1 mD, alternatively from about 0.00001 mD to about 0.1 mD, or alternatively from about 0.00001 to about 0.01 mD, alternatively from about 0.00001 mD to about 0.001 mD, or alternatively from about 0.00001 mD to about 0.0001 mD.

Currently many of these lower permeability reservoirs are completed (e.g., hydraulically fractured) with multiple stages (e.g., greater than 20, 25, 30, 35, 40, 45 or 50 stages) per lateral wellbore and multi-well pads to increase reservoir contact and reduce surface facility costs and operating costs. These pads typically contain multiple wells that are drilled from one location all in close proximity to each other on surface, but through the use of directional and horizontal drilling (e.g., forming a plurality of deviated, horizontal or lateral wellbore portions/sections sharing a common vertical section having a surface wellhead) are capable of targeting a large region within the reservoir around the pad location.

The communication in a multiwell system is typically driven by the reservoir properties including but not limited to brightness index, fracture pressure, and the degree of natural fractures. Specific interwell communication connected volumes can be increased with the CEFs of the present disclosure by lowering the interfacial tension to penetrate into smaller pore radii and increasing the distance fluid is passively imbibed, as well as, slightly etching blocked pathways to improve connected volume and permeability between hydraulic fracture conductive pathways. If there is fluid communication (intrawell) at any distance the CEFs of the present disclosure is operative as long as there is effective transport of the material (mass transport, convection). Without wishing to be limited by theory, CEFs of the present disclosure do not operate at the meter scale, but rather at the sub-millimeter scale, which is amplified due to large surface area that corresponds to such millimeters and can add to more volume of stimulated reservoir.

In some embodiments, a method of the present disclosure comprises a single-well application wherein the treatment stages are alternated or sequenced to most effectively place the CEF, often in conjunction with a proppant, along the wellbore (e.g., in a plurality of lateral wellbores sharing a common horizontal portion, with each lateral portion having multiple stages, e.g., greater than 35). In alternative embodiments, a method of the present disclosure comprises a multi-well application wherein the CEF injection periods can be alternated or sequenced between multiple wellbores (e.g., wherein each vertical wellbore forming a surface wellhead may further comprise a plurality of lateral wellbores sharing a common horizontal portion) to take advantage of pressure communication, forced imbibition, fluid miscibility and chemical/rock interaction. By designing the CEF volume to be delivered only in the stages with the most fluid communication between stages or wells, then the least amount of CEF can be placed to effectively liberate more oil from the current injector stage/well. These methods will also have a positive impact with adjacent stages/wellbores and ultimately increase recovery of natural resources over the contacted reservoir. It is contemplated the methods of the present disclosure result in a treatment design that results in more effect contact with the reservoir volume resulting in the extraction of significantly more oil from the tight reservoir matrix in situations such as multi-lateral, multi-well pads. For example, the compositions and methods of the present disclosure may result in an increase oil recovery ranging from about 25% to about 200%, alternatively from about 25% to about 100% or alternatively from about 100% to about 200%. In some embodiments, the CEF comprises a phosphonoalkyl agent, a surfactant, and a base fluid.

In some embodiments, the CEF comprises a phosphonoalkyl agent has the general formula

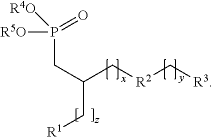

In such embodiments, R¹ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonate, or a hydrogen atom; R² is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, a phosphonoalkyl/amine, or a hydrogen atom; R³ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonoalkyl/amine, or a hydrogen atom; R⁴ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a hydrogen atom, a lithium atom, a sodium atom, a potassium atom, a cesium atom, a magnesium atom, a calcium atom, a strontium atom, a barium atom, a chromium atom, an iron atom, a manganese atom, a cobalt atom, a nickel atom, a copper atom, a gallium atom, an indium atom, or a hydrogen atom; R⁵ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a hydrogen atom, a lithium atom, a sodium atom, a potassium atom, a cesium atom, a magnesium atom, a calcium atom, a strontium atom, a barium atom, a chromium atom, an iron atom, a manganese atom a cobalt atom, a nickel atom, a copper atom, a gallium atom, an indium atom, or a hydrogen atom; x is 1 to 6; y is 0 to 6; and z is 1-6.

Examples of phosphonoalkyl agents suitable for use in the present disclosure include without limitation n-(phosphonomethyl) iminodiacetic acid (PMIDA), or salts thereof, N-(carboxymethyl)-N-(phosphonomethyl)glycine, glycine, N,N′-1,2-ethanediylbis(N-(phosphonomethyl), glyphosine, aminotrimethylene phosphonic acid, sodium aminotris(methylenephosphonate), N-(2-hydroxyethyl)iminobis (methylphosphonic acid), phosphonic acid, P,P′-((2-propen-1-ylimino)bis(methylene))bis-phosphonic acid, P,P′,P″-(nitrilotris(methylene))tris-(nitrilotris(methylene))trisphosphonic acid; ((methylimino)-dimethylene)bisphosphonic acid, P,P′,P″,P′″-(oxybis(2,1-ethanediylnitrilobis(methylene))tetrakis-((propylimino)bis(methylene))diphosphonic acid, P,P′,P″-(nitrilotris(methylene))tris-(ethylenedinitrilo)-tetramethylenephosphonic acid, ethylene-bis(nitrilodimethylene)tetraphosphonic acid, (ethylenebis(nitrilobis(methylene)))tetrakisphosphonic acid, tetrasodium tetrahydrogen (ethane-1,2-diylbis(nitrilobis(methylene)))tetrakisphosphonate, 6-(bis(phosphonomethyl)amino)hexanoic acid, (phenylmethyl)imino)bis(methylene)bisphosphonic acid, phosphonobutane tricarboxylic acid, 2-hydroxyphosphono dicarboxylic acid, a sodium salt thereof, a potassium salt thereof, an ammonium salt thereof, or a combination thereof.

In some embodiments, the phosphonoalkyl agent is a metallated mono- or diacetoaminophosphonate comprising a cation of Li, Na, K, Cs, Mg, Ca, Sr, Ba, Cr, Fe, Mn, Co, Ni, Cu, Ti, V, Mn, Zn, Zr, Ga, Al, In, or a combination thereof. In some embodiments, the phosphonoalkyl agent is a non-metallated diacetoaminophosphonate comprising a nonmetal selected from the group consisting of hydrogen ions, ammonium ions, tetraalkylammonium ions, tetraalkylphosphonium ions, a mono-, di-, or tri-alkanolamine wherein the alkyl species of the alkanol functionality can be methyl-, ethyl-, an isomer of propyl or an isomer of butyl, a nucleophile, an electrophile, a Lewis acid, a Lewis base, a Bronsted acid, a Bronsted base, an adduct of a stable complex ion, an electron donor, or combinations thereof. Furthermore, under the appropriate acid/base conditions a zwitterionic species of the phosphonoalkyl agent that can form hydrogen bridges with nucleophiles, such as Lewis bases, Bronsted bases, or form adducts where an electron donor-electron acceptor pair is stable. Such species, nucleophiles or electron donor-acceptor, may comprise a monoalkanolamine, dialkanolamine or trialkanolamine for instance; where the alkyl species of the alkanol functionality can be methyl group, ethyl group, an isomer of a propyl group or a butyl group.

The phosphonoalkyl agent may be present in the CEF in an amount of from about 0.1 wt. % to about 10 wt. %, alternatively from about 0.1 wt. % to about 1 wt. %, alternatively from about 1 wt. % to about 5 wt. % or alternatively from about 5 wt. % to about 10 wt. % based on the total weight of the CEF.

In some embodiments, CEF comprises a surfactant. Any surfactant compatible with the other components of the CEF may be suitable. In some embodiments, the surfactant comprises a fatty acid alkoxylate, an amine oxide, alkanolamide, an alkoxylated alcohol, an alkylamine alkoxylate, an alkyl glycoside surfactant, a polyethylene glycol-initiated polyol, an ethylene glycol additive, a diethanolamide of tall-oil fatty acid (TOFA), a sorbitol-initiated polyol, or a combination thereof. In some embodiments, one or more surfactants for use in the CEF comprises a fatty acid alkoxylate, an amine oxide, alkanolamide, an alkoxylated alcohol, an alkylamine alkoxylate, an alkyl glycoside surfactant, or a combination thereof.

In other embodiments, the surfactant comprises Guebert alcohols. Guerbet alcohols refer to C₈ to C₂₅ β-alkylated dimer alcohol alkoxylated with ethylene oxide (EO), propylene oxide (PO), a mixture of both, or blocked to control oil/water solubility; wherein the blocked alcohol is a product of reacting a mixture of ethylene oxide and propylene oxide of varying concentrations and the product(s) is determined by entropic and electrophilic factors. Such process entails the sequential treatment of alcohols with first EO, then PO.

In other embodiments, the surfactant comprises a Guerbet alcohol which is a C₈ to C₂₅ β-alkylated dimer alcohol alkoxylated with an ethylene oxide (EO), propylene oxide (PO), a mixture of both, or blocked to control oil/water solubility. The percent EO may range from about 10% to about 90%, and a percent PO may range from about 10% to about 90%. In some embodiments, both EO and PO are present for example in a ratio of about 4:1; alternatively, about 2:1; alternatively about 1:1; alternatively about 1:2; or alternatively about 1:4.

In some embodiments, the surfactant comprises an alcohol that may be subjected to alkoxylation. Examples of such surfactants would include, without limitation, 2-butyloctanol and/or 2-hexydecanol. Similar ratios of the combination of methyl branched alcohols and linear alcohols (4:1; 2:1; 1:1; 1:2; 1:4) alkoxylated with EO, PO, a mixture of both, or blocked to control oil/water solubility, and/or solvent, and/or water are also contemplated.

In some embodiments, the surfactant comprises mixtures of lauryl and myristal amidopropyl amine oxide, C₁₂-C₁₅ alkoxylated alcohol with 9 moles of EO, or alkoxylated with EO, PO, a mixture of both, or blocked to control oil/water solubility, sorbitol-initiated polyol, phenol formaldehyde resin with 10 mol % of ethoxylation, solvent, water or a combination thereof.

In some embodiments, the surfactant comprises the triethanolamine salt of dodecylbenzene sulfonate, monoisopropyl amine salt of dodecylbenzene sulfonate, C₁₂-C₁₅ alkoxylated alcohol with 9 moles of EO, or alkoxylated with EO, PO, a mixture of both, or blocked to control oil/water solubility, solvent, water or a combination thereof.

In some embodiments, the surfactant comprises a sulfate salt-capped secondary propoxylated alcohol (extended surfactant class). Extended surfactants are a class of molecules that undergo a sulfonation reaction after an alcohol has been subjected to sequential EO, followed by PO, or visa versa additions, to attenuate the lipophilicity of the molecule. The moles of EO may range from about 0.01 volume percent (vol. %) to about 10 vol. %, alternatively from about 0.01 vol. % to about 0.1 vol. %, alternatively from about 0.1 vol. % to about 1.0 vol. % or alternatively from about 1.0 vol. % to about 5.0 vol. % based on the amount of alcohol and moles of PO may range from about 1.0 vol. % to about 10 vol. % based on the amount of alcohol.

The surfactant may be present in the CEF in an amount of from about 0.01 vol. % to about 2.0 vol. %, alternatively from about 0.01 vol. % to about 0.1 vol. %, alternatively from about 0.1 vol. % to about 1.0 vol. %, or alternatively from about 1.0 vol. % to about 2.0 vol. % based on the volume of solution.

In some embodiments, the CEF comprises a base fluid comprising an aqueous fluid. The aqueous fluid may comprise fresh water, salt water, deionized water, produced water, flowback water, brackish water, brine, seawater, or a combination thereof. The aqueous fluid may comprise sodium bromide, calcium chloride, calcium bromide, cesium bromide, zinc bromide, potassium chloride, sodium chloride, iron (II) chloride or iron (III) chloride, silica (dissolved, colloidal, nanoparticulate, amorphous, reactive), a carbonate or bicarbonate salts, a sulfonate salt, a sulfate salt, sulfite or bisulfite salts, a phosphate or pluriphosphate salt, a phosphonate salt, a magnesium salt, a manganese salt, a bromide salt, a formate salt, an acetate salt, thiophosphate salts, a nitrate salt, or a combination thereof. The aqueous fluid may be present in an amount of from about 0.01 wt. % to about 99 wt. % based on the total weight of the wellbore servicing fluid or may comprise the rest of the composition when all other components are taken into account.

In some embodiments, a CEF of the type disclosed herein is introduced into a subterranean formation as part of a wellbore servicing operation. In alternative embodiments, the CEF is introduced to a wellbore servicing fluid that is subsequently placed into a subterranean formation as part of a wellbore servicing operation. Such wellbore servicing fluids may comprise any components compatible with the CEF and the wellbore servicing operation. For example, the wellbore servicing fluid further includes one or more additives. The one or more additives can include a friction reducer, proppant, a strength-stabilizing agent, an emulsifier, an expansion agent, a salt, a fluid loss agent, a vitrified shale, a thixotropic agent, a dispersing agent, a weight reducing additive (e.g., hollow glass or ceramic beads), a heavyweight additive, a surfactant, a scale inhibitor, a clay stabilizer, a silicate-control agent, a biocide, a biostatic agent, a storage stabilizer, a filtration control additive, a suspending agent, a foaming surfactant, latex emulsions, a formation conditioning agent, elastomers, gas/fluid absorbing materials, resins, viscosifying agents, superabsorbers, mechanical property modifying additives (i.e. carbon fibers, glass fibers, metal fibers, minerals fibers, polymeric elastomers, latexes, etc.), inert particulates, a biopolymer, a polymer, a fume silica, a free fluid control additive, particulate materials, viscosifiers, acids, bases, mutual solvents, corrosion inhibitors, conventional breaking agents, relative permeability modifiers, lime, weight-reducing agents, clay control agents, fluid loss control additives, flocculants, water softeners, foaming agents, oxidation inhibitors, thinners, scavengers, gas scavengers, lubricants, bridging agents, a foam stabilizer, catalysts, dispersants, breakers, emulsion thinner, emulsion thickener, pH control additive, lost circulation additives, buffers, stabilizers, chelating agents, oxidizers, a clay, reducers, consolidating agent, complexing agent, sequestration agent, control agent, an oxidative breaker, and the like, or combinations thereof. With the benefit of this disclosure, one of ordinary skill in the art should be able to recognize and select one or more suitable additives for use in the wellbore servicing fluid. These materials may be included singularly or in combination in amounts effective to achieve some user or process goal.

In some embodiments, a CEF of the type disclosed herein is introduced to a wellbore penetrating a subterranean formation. The CEF may be placed into a subterranean formation comprising a reservoir of the type disclosed herein (e.g., low-permeability, carbonate rich). The subterranean formation may comprise a plurality of zones having a natural resource (e.g., hydrocarbon) located proximate to the injection well. Further, the plurality of zones may comprise pathways that allow for movement of the natural resource to the injection well that is referred to herein as “fluid communication,” e.g., fluid communication allowing for the flow of fluid from an injection well, through the formation, and into a production well.

In some embodiments, the CEF is placed in at least one injection well. In some embodiments, the CEF is placed in the absence of other additives and serves as a treatment fluid. In an alternative embodiment, the CEF is a component of a wellbore servicing fluid. Without wishing to be limited by theory, introduction of a CEF of the type disclosed herein to an injection well improves the fluid communication by establishing a fluid communication network between at least a portion of the plurality of zones. In some embodiments, introduction of the CEF establishes a fluid communication network. The fluid communication network may comprise fracture to fracture communication, such as communication between hydraulic fractures formed by two or more hydraulic fracturing stages formed in a common lateral wellbore penetrating a common reservoir zone (e.g., inter-stage fracture communication in a common lateral wellbore penetrating a given/designated production zone within a reservoir). Alternatively, fracture to fracture communication may comprise communication between hydraulic fractures formed by one or more hydraulic fracturing stages formed in at least two separate lateral wellbores spaced a distance apart in a common reservoir zone (e.g., inter-stage fracture communication between two separate lateral wellbores spaced apart and penetrating a common reservoir zone). Alternatively, fracture to fracture communication may comprise communication between hydraulic fractures formed by one or more hydraulic fracturing stages formed in a first lateral wellbore penetrating a first reservoir zone and hydraulic fractures formed by one or more hydraulic fracturing stages formed in a second lateral wellbore penetrating a second reservoir zone (e.g., inter-stage fracture communication between two separate lateral wellbores spaced apart and penetrating different zones within a common reservoir). In some embodiments, the fluid communication network comprises well to well communication, for example between the injection and production wells.

In some embodiments, fracture to fracture communication comprises one or more of the aforementioned mechanisms.

In one or more embodiments, the CEF subsequent to establishing a fluid communication network has increased production of natural resources from one or more of the production wells penetrating the subterranean formation. For example, the CEF may increase fluid communication between the at least a portion of the plurality of zones and the production well by from about 10% to about 500%, alternatively from about 11% to about 100% or alternatively from about 100% to about 500%. This increase in fluid communication may result in an increase in natural resource production of from about 25% to about 200%, alternatively from about 25% to about 100% or alternatively from about 100% to about 200%.

New chemistry technology (the CEF of this disclosure) drive enhanced water imbibition into the rock matrix, rapidly altering the surface wettability and increasing oil recovery from the matrix. In some embodiments, the CEF can be included in many different wellbore servicing fluids. For example, a CEF of the type disclosed herein can be used to create a foamed wellbore servicing fluid with any suitable gas.

In some embodiments, single wells are stimulated (e.g., hydraulically fractured) in stages that are usually cookie-cutter (replicas) along the lateral and any modifications are to improve proppant placement in the individual stage. Similarly, multiple well pads are treated on an individual basis meaning that the treatment schedule is designed to work on an individual well. However, there is known fluid communication between stages and between wells and therefore treatment strategies utilizing a CEF of the type disclosed herein can be more effectively applied across a wider area by optimization of injection, production, and shut-in schedule for a treatment in stage design and multi-well pattern harnessing fluid communication to effectively treat full reservoirs with minimal treatment volumes.

The CEF and methods disclosed herein represent a novel composition and application developed and tested that uses a formulation (i.e., CEF) that is capable of facilitating communication among zones containing natural resources. Further, the CEF chemically alters surfaces within the plurality of zones that facilitates advantageous mineral dissolution at neutral or near neutral pH inducing a favorable wettability modification of the formation surface. In some embodiments, the pH of the CEF may be from about 5 to about 9 or from about 6.5 to about 8.5. Herein the pH takes its standard definition as an indication for the acidity of a substance. The outcome of a pH-measurement is determined by a consideration between the number of H+ ions and the number of hydroxide (OH—) ions. When the number of H+ ions equals the number of OH-ions, the fluid is neutral and then has a pH of about 7. The pH of the solution may be determined using any suitable methodology such as through the use of a pH electrode or indicator media.

### Additional Disclosure—Part I

The following are non-limiting, specific embodiments in accordance with the present disclosure:

A first aspect which is a method of servicing one or more wellbores penetrating a subterranean formation comprising placing into at least one of the one or more injection wells a communication fluid, wherein the subterranean formation comprises a plurality of zones having a natural resource proximate to the at least one of the one or more injection well, wherein the communication fluid establishes a fluid communication network between at least a portion of the plurality of zones, and wherein establishing of the fluid communication network results in an increased production of the natural resource from one or more production wells penetrating the subterranean formation.

A second aspect which is the method of the first aspect wherein the natural resource comprises hydrocarbons.

A third aspect which is the method of any of the first through second aspects wherein the communication fluid chemically alters at least a portion of the zones having a natural resource.

A fourth aspect which is the method of any of the first through third aspects wherein the fluid communication network increases communication between the production well and the one or more zones having a natural resource by from about 10% to about 500%.

A fifth aspect which is the method of any of the first through fourth aspects wherein the fluid communication network comprises fracture to fracture communication, for example: (a) communication between hydraulic fractures formed by two or more hydraulic fracturing stages formed in a common lateral wellbore penetrating a common reservoir zone (e.g., inter-stage fracture communication in a common lateral wellbore penetrating a given/designated production zone within a reservoir); (b) communication between hydraulic fractures formed by one or more hydraulic fracturing stages formed in at least two separate lateral wellbores spaced a distance apart in a common reservoir zone (e.g., inter-stage fracture communication between two separate lateral wellbores spaced apart and penetrating a common reservoir zone); (c) communication between hydraulic fractures formed by one or more hydraulic fracturing stages formed in a first lateral wellbore penetrating a first reservoir zone and hydraulic fractures formed by one or more hydraulic fracturing stages formed in a second lateral wellbore penetrating a second reservoir zone (e.g., inter-stage fracture communication between two separate lateral wellbores spaced apart and penetrating different zones within a common reservoir); or (d) any combination of (a) to (c).

A sixth aspect which is the method of any of the first through fifth aspects wherein the fluid communication network comprises well to well communication, for example between the injection and production wells.

A seventh aspect which is the method of any of the first through sixth aspects wherein the subterranean formation comprises an ultra-low permeability shale, a low permeability carbonate rich shale or a combination thereof.

An eighth aspect which is the method of any of the first through seventh aspects wherein the ultra-low permeability shale has been hydraulically fractured during completion.

A ninth aspect which is the method of any of the first through eighth aspects wherein the subterranean formation comprises a fractured carbonate reservoir, a sandstone reservoir, an unconventional reservoir or any combination thereof.

A tenth aspect which is the method of any of the first through ninth aspects wherein the communication fluid comprises (i) a communication enhancing agent comprising a phosphonalkyl moiety; (ii) a surfactant composition; and (iii) a base fluid.

An eleventh aspect which is the method of any of the first through tenth aspects wherein the recovery enhancing agent comprising a phosphonalkyl moiety has the general formula

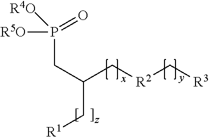

R¹ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonate, or a hydrogen atom;
R² is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, a phosphonoalkyl/amine, or a hydrogen atom;

R³ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonoalkyl/amine, or a hydrogen atom;

R⁴ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a hydrogen atom, a lithium atom, a sodium atom, a potassium atom, a cesium atom, a magnesium atom, a calcium atom, a strontium atom, a barium atom, a chromium atom, an iron atom, a manganese atom, a cobalt atom, a nickel atom, a copper atom, a gallium atom, an indium atom, or a hydrogen atom;

R⁵ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a hydrogen atom, a lithium atom, a sodium atom, a potassium atom, a cesium atom, a magnesium atom, a calcium atom, a strontium atom, a barium atom, a chromium atom, an iron atom, a manganese atom a cobalt atom, a nickel atom, a copper atom, a gallium atom, an indium atom, or a hydrogen atom;
x is 1 to 6; y is 0 to 6; and z is 1-6.

A twelfth aspect which is the method of any of the first through eleventh aspects wherein the communication enhancing agent comprising a phosphonalkyl moiety is characterized by the Structure

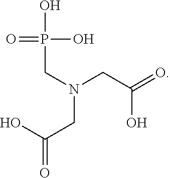 [SMILES: O=C(O)CN(CC(=O)O)CP(=O)(O)O]

A thirteenth aspect which is the method of any of the first through twelfth aspects wherein the communication enhancing agent comprising a phosphonalkyl moiety comprises n-(phosphonomethyl) iminodiacetic acid (PMIDA), N-(carboxymethyl)-N-(phosphonomethyl)glycine, glycine, N,N′-1,2-ethanediylbis(N-(phosphonomethyl), glyphosine, aminotrimethylene phosphonic acid, sodium aminotris(methylenephosphonate), N-(2-hydroxyethyl)iminobis (methylphosphonic acid), P,P′-((2-propen-1-ylimino)bis(methylene))bisphosphonic acid, P,P′,P″-(nitrilotris(methylene))tris-(nitrilotris(methylene))trisphosphonic acid, ((methylimino)dimethylene)bisphosphonic acid, P,P′,P″,P′″-(oxybis(2,1-ethanediylnitrilobis-(methylene))tetrakis-((propylimino)bis(methylene))diphosphonic acid, P,P′,P″-(nitrilotris(methylene))tris-(ethylenedinitrilo)-tetramethylenephosphonic acid, ethylenebis(nitrilodimethylene)tetraphosphonic acid, (ethylenebis(nitrilobis(methylene)))tetrakisphosphonic acid, tetrasodium tetrahydrogen (ethane-1,2-diylbis(nitrilobis(methylene)))tetrakisphosphonate, 6-(bis(phosphonomethyl)amino)hexanoic acid, (phenylmethyl)imino)bis-(methylene)bisphosphonic acid, phosphonobutane tricarboxylic acid, 2-hydroxyphosphono dicarboxylic acid, a sodium salt thereof, a potassium salt thereof, an ammonium salt thereof or a combination thereof.

A fourteenth aspect which is the method of any of the first through thirteenth aspects wherein the base fluid comprises an aqueous fluid.

A fifteenth aspect which is the method of the fourteenth aspect wherein the aqueous fluid comprises fresh water, salt water, deionized water, produced water, flowback water, brackish water, brine, seawater or a combination thereof.

A sixteenth aspect which is the method of any of the fourteenth through fifteenth aspects wherein the aqueous fluid comprises sodium bromide, calcium chloride, calcium bromide, cesium bromide, zinc bromide, potassium chloride, sodium chloride, a carbonate salt, a sulfonate sale, sulfite salts, a phosphate salt, a phosphonate salt, a magnesium salt, a bromide salt, a formate salt, an acetate salt, thiophosphate salts, phosphate salts, phosphonate salts, a nitrate salt or a combination thereof.

A seventeenth aspect which is the method of any of the fourteenth through sixteenth aspects wherein the aqueous fluid is present in an amount of from about 0.01 wt. % to about 99 wt. % based on the total weight of the communication fluid.

An eighteenth aspect which is the method of any of the fourteenth through seventeenth aspects wherein the base fluid comprises the rest of the communication fluid when all other components are taken into account.

A nineteenth aspect which is the method of any of the first through eighteenth aspects wherein the communication enhancing agent comprising a phosphonalkyl moiety further comprises a countercation.

A twentieth aspect which is the method of the nineteenth aspect wherein the countercation comprises a metal selected from the group consisting of lithium, sodium, potassium, rubidium, cesium, beryllium, magnesium, calcium, strontium, barium, chromium, iron, manganese, cobalt, nickel, copper, gallium, indium, aluminum and a combination thereof.

A twenty-first aspect which is the method of the nineteenth aspect wherein the countercation comprises a nonmetal selected from the group consisting of hydrogen ions, ammonium ions, tetraalkylammonium ions, tetraalkylphosphonium ions and a combination thereof.

A twenty-second aspect which is the method of any of the first through twenty-first aspects wherein the surfactant composition comprises a sulfate-capped primary branched or secondary propoxylated alcohol, a polyethylene glycol initiated polyol, an ethylene glycol derivative or a combination thereof.

A twenty-third aspect which is the method of any of the first through twenty-first aspects wherein the surfactant composition comprises a diethanolamide of a tall oil fatty acid, a sorbitol-initiated polyol or a combination thereof.

A twenty-fourth aspect which is the method of any the first through twenty-third aspects wherein the surfactant composition comprises a C₈ to C₂₅ β-alkoxylated dimer alcohol.

A twenty-fifth aspect which is the method of the twenty-fourth aspect wherein the C₈ to C₂₅ β-alkoxylated dimer alcohol comprises an ethoxylate moiety, a propoxylate moiety or a combination thereof.

A twenty-sixth aspect which is the method of any of the twenty-fourth through twenty-fifth aspects wherein an amount of C₈ to C₂₅ β-alkoxylated dimer alcohol is adjusted to control a hydrophobicity of the communication fluid.

A twenty-seventh aspect which is the method of any of the twenty-fourth through twenty-sixth aspects wherein the C₈ to C₂₅ β-alkoxylated dimer alcohol has an ethoxylate moiety present in an amount of from about 10 mole percent (mol. %) to about 90 mol % based on the total moles of the C₈ to C₂₅ β-alkoxylated dimer.

A twenty-eighth aspect which is the method of any of the twenty-fourth through twenty-seventh aspects wherein the C₈ to C₂₅ β-alkoxylated dimer alcohol has a propoxylate moiety present in an amount of from about 10 mole percent (mol. %) to about 90 mol % based on the total moles of the C₈ to C₂₅ β-alkoxylated dimer.

A twenty-ninth aspect which is the method of any of the twenty-fourth through twenty-eighth aspects wherein the Ce to C₂₅ β-alkoxylated dimer alcohol has an ethoxylate moiety and a propoxylate moiety present in ratio of from about 4:1, alternatively from about 2:1, alternatively from about 1:1, alternatively from about 1:2 or alternatively from about 1:4.

A thirtieth aspect which is the method of any of the twenty-fourth through twenty-ninth aspects wherein the C₈ to C₂₅ β-alkoxylated dimer alcohol comprises 2-butyloctanol, 2-hexyldecanol or a combination thereof.

A thirty-first aspect which is the method of any of the first through twenty-third aspects wherein the surfactant composition comprises an alkyl-branched alcohol, a linear alcohol or a combination thereof.

A thirty-second aspect which is the method of the thirty-first aspect wherein the alkyl-branched alcohol comprises an ethoxylate moiety, a propoxylate moiety or a combination thereof.

A thirty-third aspect which is the method of the thirty-first aspect wherein the linear alcohol comprises an ethoxylate moiety, a propoxylate moiety or a combination thereof.

A thirty-fourth aspect which is the method of the thirty-first aspect wherein the methyl-branched alcohol has an ethoxylate moiety and a propoxylate moiety present in a ratio of from about 4:1, alternatively from about 2:1, alternatively from about 1:1, alternatively from about 1:2 or alternatively from about 1:4.

A thirty-fifth aspect which is the method of the thirty-first aspect wherein the linear alcohol has an ethoxylate moiety and a propoxylate moiety present in a ratio of from about 4:1, alternatively from about 2:1, alternatively from about 1:1, alternatively from about 1:2 or alternatively from about 1:4.

A thirty-sixth aspect which is the method of any of the first through twenty-first aspects wherein the surfactant composition comprises a C₂-C₁₅ alkoxylated alcohol having about 9 moles of ethoxylate, an ethoxylated C₁₂-C₁₅ alcohol, a propoxylated C₁₂-C₁₅ alcohol, a combination of an ethoxylated C₁₂-C₁₅ alcohol and a propoxylated C₁₂-C₁₅ alcohol, a sorbitol-initiated polyol, a phenol formaldehyde resin with about 10 mol. % of ethoxylation or a combination thereof.

A thirty-seventh aspect which is the method of any of the first through twenty-first aspects wherein the surfactant composition comprises a triethanolamine salt of dodecylbenzene sulfate, a monoisopropyl amine salt of dodecylbenzene sulfonate; a C₁₂-C₁₅ alkoxylated alcohol having about 9 moles of ethoxylate, a propoxylated C₁₂-C₁₅ alcohol, a combination of an ethoxylated C₁₂-C₁₅ alcohol and a propoxylated C₁₂-C₁₅ alcohol or a combination thereof.

A thirty-eighth aspect which is the method of any of the first through twenty-first aspects wherein the surfactant composition comprises a fatty acid alkoxylate, an amine oxide, alkanolamide, an alkoxylated alcohol, an alkylamine alkoxylate, an alkyl glycoside surfactant or a combination thereof.

### Additional Disclosure—Part 11

The following are non-limiting, specific embodiments in accordance with the present disclosure:

A first aspect which is a method of servicing one or more wellbores penetrating a subterranean formation comprising placing into at least one of one or more injection wells a communication enhancing fluid, wherein the subterranean formation comprises a plurality of zones having a natural resource proximate to the at least one of the one or more injection wells, wherein the communication enhancing fluid establishes a fluid communication network between at least a portion of the plurality of zones, and wherein establishing of the fluid communication network results in an increased production of the natural resource from one or more production wells penetrating the subterranean formation.

A second aspect which is the method of the first aspect wherein the natural resource comprises hydrocarbons.

A third aspect which is the method of the first aspect wherein the communication enhancing fluid chemically alters at least a portion of the zones having a natural resource.

A fourth aspect which is the method of the first aspect wherein the fluid communication network increases communication between the production well and the one or more zones having a natural resource by from about 10% to about 500%.

A fifth aspect which is the method of the first aspect wherein the fluid communication network comprises fracture to fracture communication.

A sixth aspect which is the method of the fifth aspect wherein fracture to fracture communication comprises (a) communication between hydraulic fractures formed by two or more hydraulic fracturing stages formed in a common lateral wellbore penetrating a common reservoir zone; (b) communication between hydraulic fractures formed by one or more hydraulic fracturing stages formed in at least two separate lateral wellbores spaced a distance apart in a common reservoir zone; (c) communication between hydraulic fractures formed by one or more hydraulic fracturing stages formed in a first lateral wellbore penetrating a first reservoir zone and hydraulic fractures formed by one or more hydraulic fracturing stages formed in a second lateral wellbore penetrating a second reservoir zone; or (d) any combination of (a)-(c).

A seventh aspect which is the method of the first aspect wherein the fluid communication network comprises well to well communication.

An eighth aspect which is the method of the first aspect wherein the subterranean formation comprises an ultra-low permeability shale, a low permeability carbonate rich shale, or a combination thereof.

A ninth aspect which is the method of the eighth aspect wherein the ultra-low permeability shale, low permeability carbonate rich shale, or both have a permeability of from about 0.00001 millidarcies to about 1 millidarcies.

A tenth aspect which is the method of the first aspect wherein the subterranean formation comprises a fractured carbonate reservoir, a sandstone reservoir, an unconventional reservoir, or a combination thereof.

An eleventh aspect which is the method of the first aspect wherein the communication enhancing fluid comprises (i) a communication enhancing agent comprising a phosphonalkyl moiety; (ii) a surfactant; and (iii) a base fluid.

A twelfth aspect which is the method of the eleventh aspect wherein the communication enhancing agent comprising a phosphonalkyl moiety has the general formula:

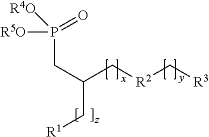

wherein R¹ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonate, or a hydrogen atom; R² is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, a phosphonoalkyl/amine, or a hydrogen atom; R³ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonoalkyl/amine, or a hydrogen atom; R⁴ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom, a cobalt atom, a nickel atom, a copper atom, a gallium atom, an indium atom, or a hydrogen atom; R⁵ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom a cobalt atom, a nickel atom, a copper atom, a gallium atom, an indium atom, or a hydrogen atom; x is 1 to 6; y is 0 to 6; and z is 1-6.

A thirteenth aspect which is the method of the eleventh aspect wherein the communication enhancing agent comprising a phosphonalkyl moiety is characterized by the Structure:

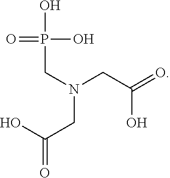 [SMILES: O=C(O)CN(CC(=O)O)CP(=O)(O)O]

A fourteenth aspect which is the method of the eleventh aspect wherein the communication enhancing agent comprising a phosphonalkyl moiety comprises n-(phosphonomethyl) iminodiacetic acid (PMIDA), N-(carboxymethyl)-N-(phosphonomethyl)glycine, glycine, N,N′-1,2-ethanediylbis(N-(phosphonomethyl), glyphosine, aminotrimethylene phosphonic acid, sodium aminotris(methylenephosphonate), N-(2-hydroxyethyl)iminobis (methylphosphonic acid), P,P′-((2-propen-1-ylimino)bis(methylene))bis-phosphonic acid, P,P′,P″-(nitrilotris(methylene))tris-(nitrilotris(methylene))trisphosphonic acid, ((methylimino)dimethylene)bisphosphonic acid, P,P′,P″,P′″-(oxybis(2,1-ethanediylnitrilobis-(methylene))tetrakis-((propylimino)bis(methylene))diphosphonic acid, P,P′,P″-(nitrilotris(methylene))tris-(ethylenedinitrilo)-tetramethylenephosphonic acid, ethylenebis(nitrilodimethylene)tetraphosphonic acid, (ethylenebis(nitrilobis(methylene)))tetrakisphosphonic acid, tetrasodium tetrahydrogen (ethane-1,2-diylbis(nitrilobis(methylene)))tetrakisphosphonate, 6-(bis(phosphonomethyl) amino)hexanoic acid, (phenylmethyl)imino)bis-(methylene)bisphosphonic acid, phosphonobutane tricarboxylic acid, 2-hydroxyphosphono dicarboxylic acid, a sodium salt thereof, a potassium salt thereof, an ammonium salt thereof, or a combination thereof.

A fifteenth aspect which is the method of the eleventh aspect wherein the base fluid comprises an aqueous fluid.

A sixteenth aspect which is the method of the fifteenth aspect wherein the aqueous fluid comprises fresh water, salt water, deionized water, produced water, flowback water, brackish water, brine, seawater, or a combination thereof.

A seventeenth aspect which is the method of the fifteenth aspect wherein the aqueous fluid comprises sodium bromide, calcium chloride, calcium bromide, cesium bromide, zinc bromide, potassium chloride, sodium chloride, iron (II) chloride or iron (HI) chloride, silica (dissolved, colloidal, nanoparticulate, amorphous, reactive), a carbonate or bicarbonate salts, a sulfonate salt, a sulfate salt, sulfite or bisulfite salts, a phosphate or pluriphosphate salt, a phosphonate salt, a magnesium salt, a manganese salt, a bromide salt, a formate salt, an acetate salt, thiophosphate salts, a nitrate salt, or a combination thereof.

An eighteenth aspect which is the method of the fifteenth aspect wherein the aqueous fluid is present in an amount of from about 0.01 wt. % to about 99 wt. % based on the total weight of the communication fluid.

A nineteenth aspect which is the method of the eleventh aspect wherein the surfactant comprises a sulfate-capped primary branched or secondary propoxylated alcohol, a polyethylene glycol-initiated polyol, an ethylene glycol derivative, a diethanolamide of a tall oil fatty acid, a sorbitol-initiated polyol, comprises a C₈ to C₂₅ β-alkoxylated dimer alcohol, fatty acid alkoxylate, an amine oxide, alkanolamide, an alkoxylated alcohol, an alkylamine alkoxylate, an alkyl glycoside surfactant or a combination thereof.

A twentieth aspect which is the method of the first aspect wherein natural resource recovery from the production well is increased by from about 25% to about 200%.

### EXAMPLES

### Example 1

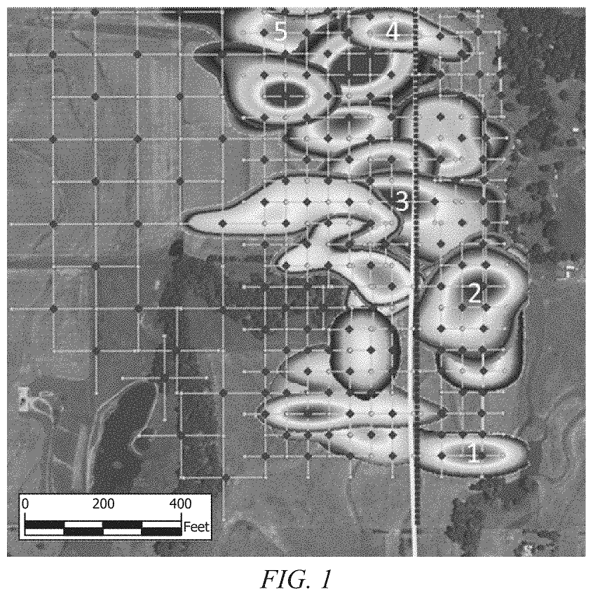

Example 1 investigated an aerial view of the movement of fluid between stages in a wellbore. All these stages were designed to maximize the wellbore coverage but communication was meant to be avoided. However, some of the stages remain isolated (i.e. Point 1), while others cover a larger area on a single side of the wellbore (Point 2), or expand to both sides of the wellbore (Point 3) or only impact a small area (Point 4) or leak off to stimulate another well (Point 5). Using stage spacing that maximizes the treatment volumes only for the stages with the most connection to the reservoir would reduce the amount of communication fluid applied to the well overall saving cost and maximizing placement within the reservoir. For example, this scenario would omit treatment to Zone 1, then add stage spaced between Zone 1&2 that would connect both of those areas. The method would further omit communication fluid in Zone 2 and add communication fluid to Zone 3 (FIG. 1). More clusters spaced closer together, with most having small volumes of just communication fluid and proppant adjacent to zones with larger volumes containing fluid, proppant and communication fluid

### Example 2

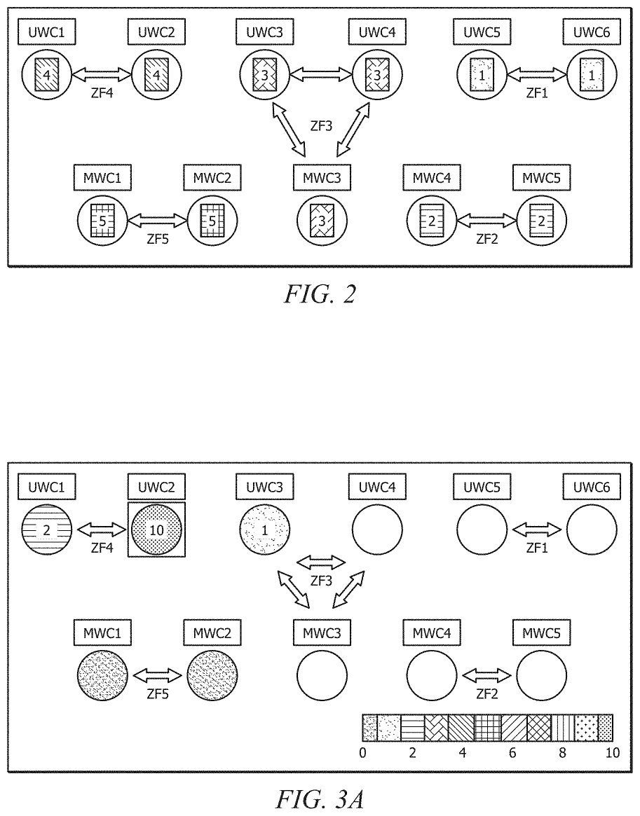

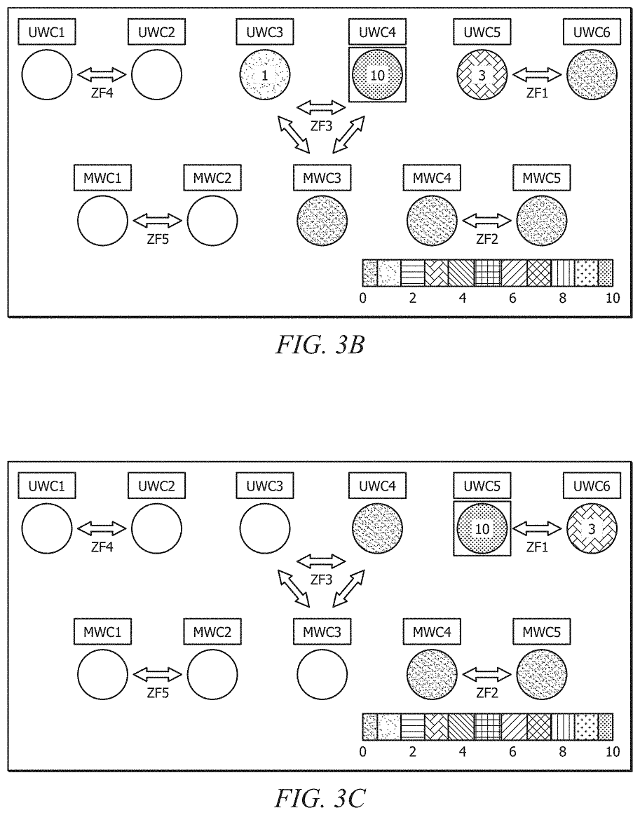

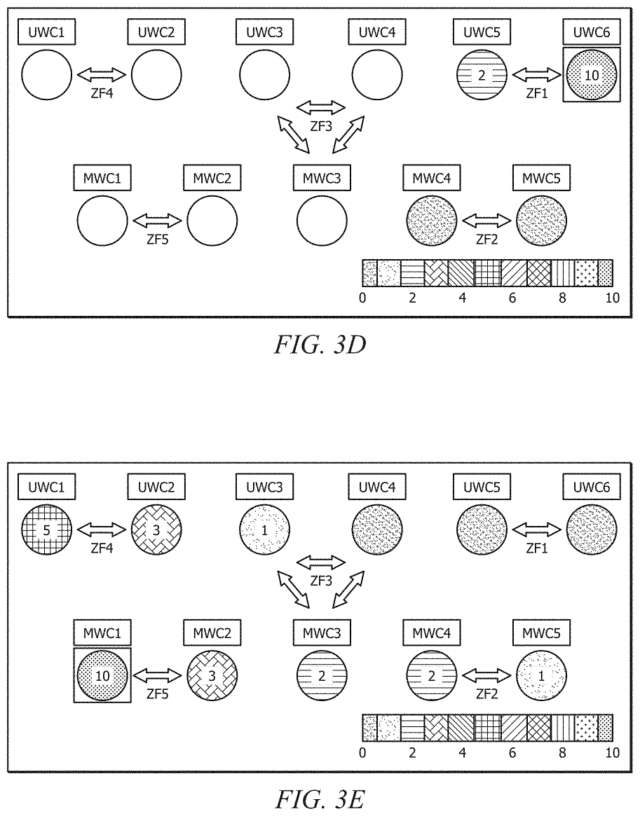

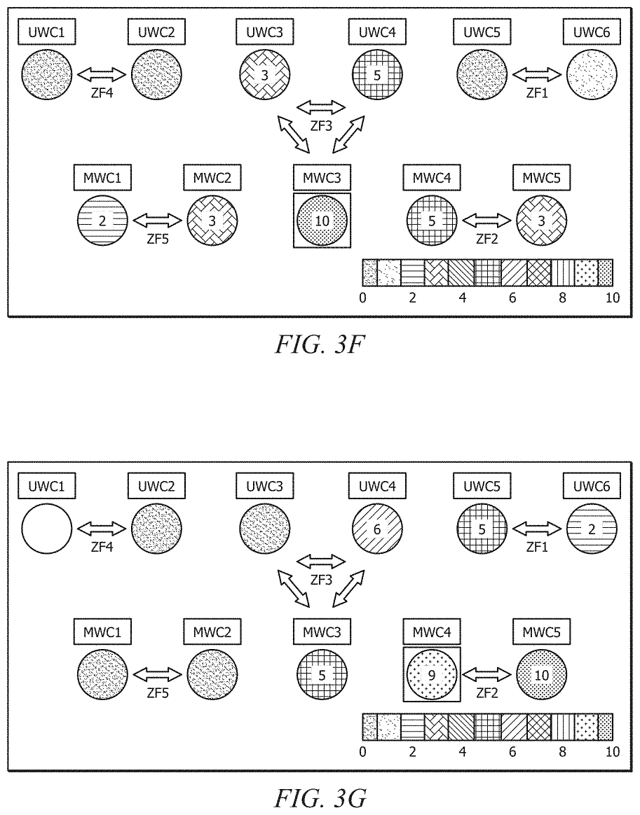

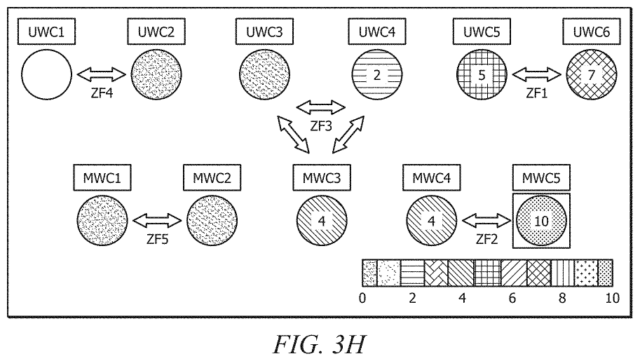

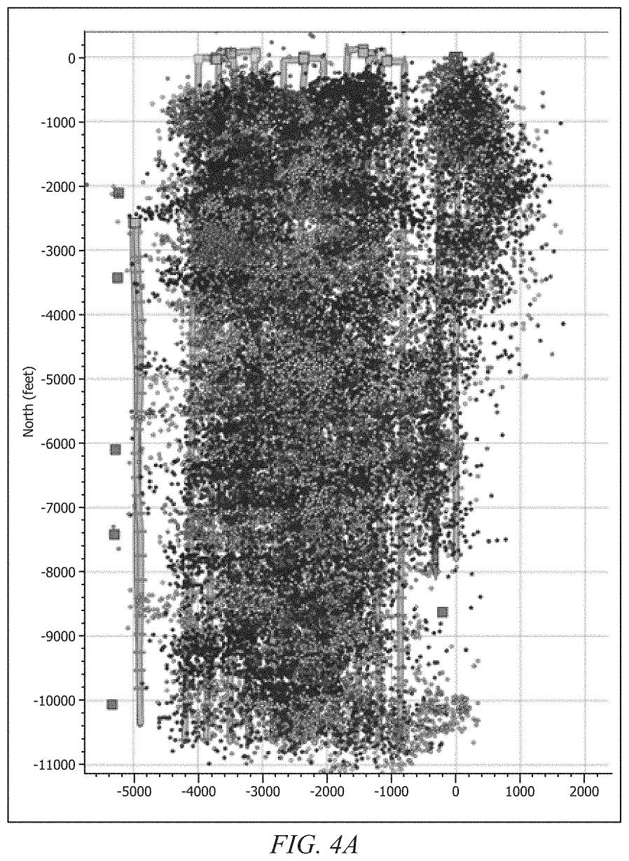

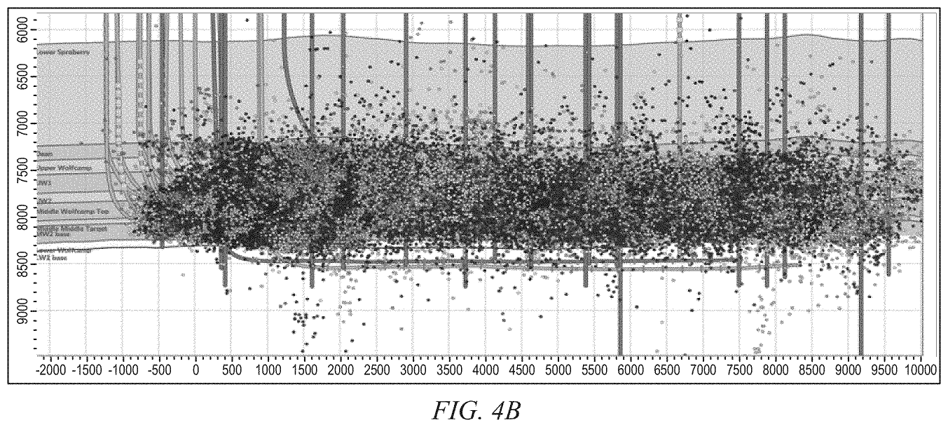

Example 2 shows where 11 wells on the same pad were evaluated for pressure, communication fluid, and proppant communication. The completion schedule and well placement is shown in FIG. 2. The orientation of this figure is looking at a cross section of the formation and looking directly into the wellbores, often referred to in the industry as a gun barrel view. FIGS. 3A-3D show the wells that have communication of a water-soluble tracer following the treatment of different wells. The water-soluble treatment applied to injection schedules for FIGS. 3-6 are only picked up in 3-6 additional wells on the pad, and only at low concentrations. However, a treatment applied in the scheduled depicted for FIGS. 3E-3H have communication to all wells on the pad. This suggests that the later completed wells connect into a hydraulic fracture system that has been created by the previous wells. This extent of cross well communication during the initial completion of these wells provides a means of exposing a very large volume of reservoir rock to a desired chemical solution to enhance fluid imbibition and enhance oil mobility. With optimized dosage and volumes, this fluid communication can be used to effectively optimize the treatment design for synergistic formulation—minimizing the volume and cost to the customer and maximizing the impact to production across the whole pad. In this case, the extent of the stimulated rock volume for all 11 wells can be seen in the microseismic data that was collected during the fracturing operations for this project shown in FIGS. 4A and 4B. Each one of these microseismic points represent a hydraulic fracture induced shear failure within the rock. When combined they are a good representation of the extent and degree of disruption and ultimately simulation that has occurred within the volume of rock.

Any chemical treatment could be placed using this strategy; however, synergy fluids have greater imbibition and depth of penetration into the formation, therefore would maximizing the potential for communication beyond the primary stimulated facture.

The subject matter having been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

We claim:

1. A method of servicing one or more wellbores penetrating a subterranean formation comprising placing into at least one of one or more injection wells a communication enhancing fluid, wherein the subterranean formation comprises a plurality of zones having a natural resource proximate to the at least one of the one or more injection wells,
wherein the communication enhancing fluid establishes a fluid communication network between at least a portion of the plurality of zones, and
wherein establishing of the fluid communication network results in an increased production of the natural resource from one or more production wells penetrating the subterranean formation.

2. The method of claim 1 wherein the natural resource comprises hydrocarbons.

3. The method of claim 1 wherein the communication enhancing fluid chemically alters at least a portion of the zones having a natural resource.

4. The method of claim 1 wherein the fluid communication network increases communication between the production well and the one or more zones having a natural resource by from about 10% to about 500%.

5. The method of claim 1 wherein the fluid communication network comprises fracture to fracture communication.

6. The method of claim 5 wherein fracture to fracture communication comprises:
(a) communication between hydraulic fractures formed by two or more hydraulic fracturing stages formed in a common lateral wellbore penetrating a common reservoir zone;
(b) communication between hydraulic fractures formed by one or more hydraulic fracturing stages formed in at least two separate lateral wellbores spaced a distance apart in a common reservoir zone;
(c) communication between hydraulic fractures formed by one or more hydraulic fracturing stages formed in a first lateral wellbore penetrating a first reservoir zone and hydraulic fractures formed by one or more hydraulic fracturing stages formed in a second lateral wellbore penetrating a second reservoir zone; or
(d) any combination of (a)-(c).

7. The method of claim 1 wherein the fluid communication network comprises well to well communication.

8. The method of claim 1 wherein the subterranean formation comprises an ultra-low permeability shale, a low permeability carbonate rich shale, or a combination thereof.

9. The method of claim 8 wherein the ultra-low permeability shale, low permeability carbonate rich shale, or both have a permeability of from about 0.00001 millidarcies to about 1 millidarcies.

10. The method of claim 1 wherein the subterranean formation comprises a fractured carbonate reservoir, a sandstone reservoir, an unconventional reservoir, or a combination thereof.

11. The method of claim 1 wherein the communication enhancing fluid comprises (i) a communication enhancing agent comprising a phosphonalkyl moiety; (ii) a surfactant; and (iii) a base fluid.

12. The method of claim 11 wherein the communication enhancing agent comprising a phosphonalkyl moiety has the general formula: 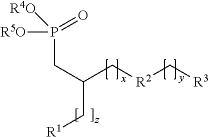
wherein R¹ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonate, or a hydrogen atom;
R² is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, a phosphonoalkyl/amine, or a hydrogen atom;
R³ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonoalkylamine, or a hydrogen atom;
R⁴ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom, a cobalt atom, a nickel atom, a copper atom, a gallium atom, an indium atom, or a hydrogen atom;
R⁵ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom a cobalt atom, a nickel atom, a copper atom, a gallium atom, an indium atom, or a hydrogen atom;
x is 1 to 6;
y is 0 to 6; and
z is 1-6.

13. The method of claim 11 wherein the communication enhancing agent comprising a phosphonalkyl moiety is characterized by the Structure:

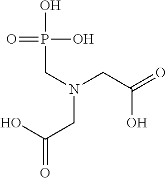 [SMILES: O=C(O)CN(CC(=O)O)CP(=O)(O)O]

14. The method of claim 11 wherein the communication enhancing agent comprising a phosphonalkyl moiety comprises n-(phosphonomethyl) iminodiacetic acid (PMIDA), N-(carboxymethyl)-N-(phosphonomethyl)glycine, glycine, N,N′-1,2-ethanediylbis(N-(phosphonomethyl), glyphosine, aminotrimethylene phosphonic acid, sodium aminotris(methylenephosphonate), N-(2-hydroxyethyl)iminobis (methylphosphonic acid), phosphonic acid, P,P′-((2-propen-1-ylimino)bis(methylene))bis-phosphonic acid, P,P′,P″-(nitrilotris(methylene))tris-(nitrilotris(methylene))trisphosphonic acid, ((methylimino)dimethylene)bisphosphonic acid, P,P′,P″,P′″-(oxybis(2,1-ethanediylnitrilobis-(methylene))tetrakis-((propylimino)bis(methylene))diphosphonic acid, P,P′,P″-(nitrilotris(methylene))tris-(ethylenedinitrilo)-tetramethylenephosphonic acid, ethylenebis(nitrilodimethylene)tetraphosphonic acid, (ethylenebis(nitrilobis(methylene)))tetrakisphosphonic acid, tetrasodium tetrahydrogen (ethane-1,2-diylbis(nitrilobis(methylene)))tetrakisphosphonate, 6-(bis(phosphonomethyl) amino)hexanoic acid, (phenylmethyl)imino)bis-(methylene)bisphosphonic acid, phosphonobutane tricarboxylic acid, 2-hydroxyphosphono dicarboxylic acid, a sodium salt thereof, a potassium salt thereof, an ammonium salt thereof, or a combination thereof.

15. The method of claim 11 wherein the base fluid comprises an aqueous fluid.

16. The method of claim 15 wherein the aqueous fluid comprises fresh water, salt water, deionized water, produced water, flowback water, brackish water, brine, seawater, or a combination thereof.

17. The method of claim 15 wherein the aqueous fluid comprises sodium bromide, calcium chloride, calcium bromide, cesium bromide, zinc bromide, potassium chloride, sodium chloride, iron (II) chloride or iron (III) chloride, silica (dissolved, colloidal, nanoparticulate, amorphous, reactive), a carbonate or bicarbonate salts, a sulfonate salt, a sulfate salt, sulfite or bisulfite salts, a phosphate or pluriphosphate salt, a phosphonate salt, a magnesium salt, a manganese salt, a bromide salt, a formate salt, an acetate salt, thiophosphate salts, a nitrate salt, or a combination thereof.

18. The method of claim 15 wherein the aqueous fluid is present in an amount of from about 0.01 wt. % to about 99 wt. % based on the total weight of the communication fluid.

19. The method of claim 11 wherein the surfactant comprises a sulfate-capped primary branched or secondary propoxylated alcohol, a polyethylene glycol-initiated polyol, an ethylene glycol derivative, a diethanolamide of a tall oil fatty acid, a sorbitol-initiated polyol, comprises a C₈ to C₂₅ β-alkoxylated dimer alcohol, fatty acid alkoxylate, an amine oxide, alkanolamide, an alkoxylated alcohol, an alkylamine alkoxylate, an alkyl glycoside surfactant or a combination thereof.

20. The method of claim 1 wherein natural resource recovery from the production well is increased by from about 25% to about 200%.
